(19) United States
(12) Patent Application Publication
(10) Pub. No.: US 2023/0148562 A1
(43) Pub. Date: May 18, 2023

(54) ANIMAL STRUCTURE

(71) Applicant: Ahmad Eivaz, San Marcos, CA (US)

(72) Inventor: Ahmad Eivaz, San Marcos, CA (US)

(21) Appl. No.: 17/986,190

(22) Filed: Nov. 14, 2022

Related U.S. Application Data
(60) Provisional application No. 63/279,059, filed on Nov. 12, 2021.

(51) Int. Cl. A01K 1/03; F16B 7/18; F16B 9/02

(52) U.S. Cl. CPC A01K 1/03; F16B 7/182; F16B 9/02

(57) ABSTRACT

An improved animal structure is disclosed. The structure includes various features which can improve transportation, ease of assembly, structural integrity, and/or aesthetic quality. The animal structure includes a post having multiple post sections, namely a first post section and a second post section. The first and section post sections are coupled to together by a post coupler wherein the post coupler is disposed completely within a hollow interior of the post when the first post section is flush with the second post section.

### CROSS-REFERENCE TO RELATED APPLICATIONS

This application claims benefit of priority with U.S. Provisional Application Ser. No. 63/279,059, filed Nov. 12, 2021; the entire contents of which are hereby incorporated by reference.

### BACKGROUND

### Field of the Invention

This disclosure relates to an improved animal structure and more particularly to an animal structure having improved assembly.

### Description of the Related Art

Animal structures, such as those used by cats and dogs, are typically large in size. E-commerce and brick-and-motor businesses usually have to choose between selling the structures already built, which increases shipping costs and retail shelf space, or to sell the structures disassembled, which puts a burden on the purchaser. Additionally, having the purchaser build the animal structure puts an additional tradeoff on the designers between ease of assembly, structural integrity and aesthetic quality.

There is a need for an improved animal structure which can be shipped and stored in a compact form factor, in addition to being easy to assemble while maintaining structural integrity and an overall desirable look.

### SUMMARY

An improved animal structure is disclosed. The structure may comprise various features which can improve transportation, ease of assembly, structural integrity, and/or aesthetic quality. The animal structure includes a post having multiple post sections, namely a first post section and a second post section. The first and section post sections are coupled to together by a post coupler wherein the post coupler is disposed completely within a hollow interior of the post when the first post section is flush with the second post section.

In some embodiments, the post comprises a stability system disposed where the first and second post sections are joined and provide increase structural integrity. The stabilizer system comprises a first stabilizer and a second stabilizer. An optional second elevated portion can be disposed between the first and second stabilizer. The first and second stabilizers are joined by one or more fasteners.

In some embodiments, a base of the structure may comprise modular pieces including a bottom portion, a top portion, a front portion, a back portion, and sides portions. The top and bottom portions comprise a plurality of guides and a plurality of male attachments. The front and back portions comprise a plurality of guide receivers and a plurality of female attachments and are configured to receive the plurality of guides and plurality of male attachments respectively. The side portions are attached last by an attachment mechanism.

In some embodiments, the base is configurable in a collapsed state and in an expanded state. The base comprises a crease or hinge at a midsection of the front and back portions, thereby causing the front and back portions to fold in half and allow the top portion to lower and rest on the bottom portion. The sides portions are hingedly coupled to the top portion and are configured to rotate down towards the bottom portion to put the base into the expanded state.

### BRIEF DESCRIPTION OF THE DRAWINGS

Other features, combinations, and embodiments will be appreciated by one having the ordinary level of skill in the art upon a thorough review of the following details and descriptions, particularly when reviewed in conjunction with the drawings, wherein:

FIG. 1 shows a side view of an improved animal structure having a post coupled by a post coupler according to a first illustrated embodiment;

FIG. 2 shows a side view of the post with a male subcomponent disposed therein according to the first illustrated embodiment;

FIG. 3 shows a side view of the post coupler according to the first illustrated embodiment;

FIG. 4A shows an alternate side view of the post coupler according to the first illustrated embodiment;

FIG. 4B shows the post coupled by the post coupler according to the first illustrated embodiment;

FIG. 5 shows perspective view of the improved animal structure according to an embodiment;

FIG. 6 shows side view of a stabilizer system according to a second illustrated embodiment;

FIG. 7A shows a modular base in accordance to a third illustrated embodiment;

FIG. 7B shows a top view of a connecting mechanism according to the third illustrated embodiment;

FIG. 7C shows a side view of a male attachment and a female attachment according to the third illustrated embodiment;

FIG. 8A shows a side view of a collapsible base in accordance with a fourth illustrated embodiment;

FIG. 8B shows an alternate side view of the collapsible base according to the fourth illustrated embodiment;

FIG. 8C shows an internal view of the collapsible base according to the fourth illustrated embodiment; and

FIG. 9 shows a perspective view of the post coupler in accordance with a fifth illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “animal structure” means a structure used by any animal capable of utilizing said animal structure for leisure, entertainment, and/or exercise. Examples may include dogs, cats, birds, reptiles, or any other animal that can be appreciated by one having skill in the art.

The term “male” means a connector or attachment that can be inserted into a corresponding female connector or attachment. Examples may include thread, friction fit, ratchet, and any other coupling as can be appreciated by one having skill in the art.

The term “female” means a connector or attachments that can receive a corresponding male connector or attachment. Examples may include thread, friction fit, ratchet, and any other coupling as can be appreciated by one having skill in the art.

Unless explicitly defined herein, terms are to be construed in accordance with the plain and ordinary meaning as would be appreciated by one having skill in the art. General Description of Embodiments

In one embodiment, an improved animal structure is disclosed. The improved animal structure comprises a post comprising a first post section and a second post section configured to detach from the first post section, the first post section comprising a first distal end and a first proximal end opposite the first distal end, the second post section comprising a second distal end and a second proximal end opposite the first distal end, the post further comprising a hollow interior forming an inner wall. The improved animal structure further comprises a base coupled to the first post section at the first proximal end, and a post coupler coupled to the post at both the first distal end and the second proximal end, wherein the post coupler is disposed entirely within the hollow interior. The post coupler comprises a male subcomponent and a female subcomponent. The male subcomponent comprises a male connector coupled to a male body, the male body comprising a male outer periphery wherein the male outer periphery is coupled to the inner wall of the post. The female subcomponent is configured to engage with the male subcomponent, the female subcomponent having a female body with a wall extension extending from the female body, the wall extension comprising a female connector, the female body further comprising a female outer periphery wherein the female outer periphery is coupled to the inner wall of the post. A plurality of ridges is disposed on both the male outer periphery and the female outer periphery. The plurality of ridges extends in a same direction as the post, and comprises a thickness configured to conform to the inner wall. A plurality of apertures extends through both the male body and the female body, wherein a plurality of fasteners extends through the post and engages with the plurality of apertures. The male body and female body are fully disposed within the hollow interior. A median elevated platform is coupled to the post by a stabilizer system, the stabilizer system comprising a first stabilizer component coupled to a first surface of the median elevated platform, a second stabilizer component coupled to a second surface of the median platform, and a plurality of fastener apertures, wherein each of the plurality of fastener apertures extends completely through the first stabilizer component and the median elevated platform, and further wherein each of the plurality of fastener apertures extends partially into the second stabilizer component.

In some embodiments, the post may further comprise one of a male portion or female portion coupled to the inner wall of the first proximal end, wherein the male portion or female portion is configured to engage with a base coupler, the base coupler being attached to the base.

In some embodiments, the base may further comprise a collapsible base, the collapsible base comprising a top portion, a bottom portion opposite the top portion, a front portion coupled to each of the top portion and the bottom portion, a back portion opposite the front portion, the back portion coupled to each of the top portion and the bottom portion, and a plurality of side portions hingedly coupled to the top portion. The front portion and the back portion each comprise a hinge extending along a corresponding midsection, thereby allowing the front and back portions to fold and cause the top portion to collapse onto the bottom portion.

In some embodiments, the bottom portion may further comprise a plurality of stoppers wherein each stopper is configured to prevent the plurality of side portions from rotating outwards from the bottom portion.

In some embodiments, the bottom portion may further comprise a plurality of support bars, the plurality of support bars being coupled to the bottom portion to prevent the plurality of side portions from rotating into a collapsed state, wherein each of the plurality of side portions is held in place by one of the plurality of stoppers on a side and one of the plurality of support bars on an opposite side.

In some embodiments, the base may further comprise a modular base, the modular base comprising a bottom portion, the bottom portion comprising a plurality of guides and a plurality of male attachments, a front portion and a back portion opposite the front portion, wherein the front portion and the back portion each comprise one or more guide receivers configured to engage with one of the plurality of guides, the front portion and back portion each comprising a plurality of female attachments each configured to engage with one of the plurality of male attachments, and a plurality of side portions configured to couple to each of the front portion and the back portion by a connecting mechanism.

In some embodiments, the male subcomponent may further comprise a cavity extending through each of the male body and male connector, wherein a core support is disposed within the cavity.

In some embodiments, the male subcomponent may further comprise a subcomponent density and the core support comprising a core density, wherein the core density is less than the subcomponent density.

In another embodiments, an improved animal structure is disclosed. The improved animal structure comprises a post comprising a first post section and a second post section configured to detach from the first post section, the first post section comprising a first distal end and a first proximal end opposite the first distal end, the second post section comprising a second distal end and a second proximal end opposite the first distal end, the post further comprising a hollow interior forming an inner wall. A base is coupled to the first post section at the first proximal end and a post coupler coupled to the post at both the first distal end and the second proximal end, wherein the post coupler is disposed entirely within the hollow interior. The post coupler comprises a male subcomponent, the male subcomponent having a male connector coupled to a male body, the male body comprising a male outer periphery wherein the male outer periphery is coupled to the inner wall of the post. The post coupler further comprises a female subcomponent configured to engage with the male subcomponent, the female subcomponent having a female body with a wall extension extending from the female body, the wall extension comprising a female connector, the female body further comprising a female outer periphery wherein the female outer periphery is coupled to the inner wall of the post.

In some embodiments, the post coupler may further comprise a plurality of ridges disposed on both the male outer periphery and the female outer periphery.

In some embodiments, the plurality of ridges may extend in a same direction as the post wherein direction of the post is defined as extending from one end of the post (such as the first proximal end) to another end of the post (such as the second distal end).

In some embodiments, the post coupler may further comprise a plurality of apertures extending through both the male body and the female body, wherein a plurality of fasteners extends through the post and engages with the plurality of apertures.

In some embodiments, the improved animal structure may further comprise a median elevated platform coupled to the post by a stabilizer system. The stabilizer system comprises a first stabilizer component coupled to a first surface of the median elevated platform, a second stabilizer component coupled to a second surface of the median platform, and a plurality of fastener apertures, wherein each of the plurality of fastener apertures extends completely through the first stabilizer component and the median elevated platform, and further wherein each of the plurality of fastener apertures extends partially into the second stabilizer component.

In some embodiments, the post may further comprise one of a male portion or female portion coupled to the inner wall of the first proximal end, wherein the male portion or female portion is configured to engage with a base coupler, the base coupler being attached to the base.

In some embodiments, the post may further comprise one of a male portion or female portion coupled to the inner wall of the second distal end, wherein the male portion or female portion is configured to engage with the upper elevated platform.

In some embodiments, the base may further comprise a collapsible base, the collapsible base comprising a top portion, a bottom portion opposite the top portion, a front portion coupled to each of the top portion and the bottom portion, a back portion opposite the front portion, the back portion coupled to each of the top portion and the bottom portion, and a plurality of side portions hingedly coupled to the top portion. The front portion and the back portion each comprise a hinge extending along a corresponding midsection, thereby allowing the front and back portions to fold and cause the top portion to collapse onto the bottom portion.

In some embodiments, the bottom portion may further comprise a plurality of stoppers wherein each stopper is configured to prevent the plurality of side portions from rotating outwards from the bottom portion.

In some embodiments, the bottom portion may further comprise a plurality of support bars, the plurality of support bars being coupled to the bottom portion to prevent the plurality of side portions from rotating into a collapsed state, wherein each of the plurality of side portions is held in place by one of the plurality of stoppers on a side and one of the plurality of support bars on an opposite side.

In some embodiments, the base may further comprise a modular base, the modular base comprising a bottom portion, the bottom portion comprising a plurality of guides and a plurality of male attachments, a front portion and a back portion opposite the front portion, wherein the front portion and the back portion each comprise one or more guide receivers configured to engage with one of the plurality of guides, the front portion and back portion each comprising a plurality of female attachments each configured to engage with one of the plurality of male attachments, and a plurality of side portions configured to couple to each of the front portion and the back portion by a connecting mechanism.

In some embodiments, the plurality of ridges may comprise a thickness configured to conform to the inner wall.

In some embodiments, the male body and the female body are fully disposed within the hollow interior.

In some embodiments, the male subcomponent may further comprise a cavity extending through each of the male body and male connector, wherein a core support is disposed within the cavity.

In some embodiments, the male subcomponent may further comprise a subcomponent density and the core support comprising a core density, wherein the core density is less than the subcomponent density.

In other embodiments, the improved animal structure may comprises the post coupler, the stabilizer system, the collapsible base, the modular base, or a combination thereof.

### Manufacturing

Materials used to build structures as disclosed herein may comprise a plurality and variety of materials that can be appreciated by one having skill in the art. Materials that can be used may include plywood, MDF, hardwood, particle board and/or pressed wood. The post coupler may made from wood, metal, or thermoplastics. The posts may comprise PVC, ABS or other plastic materials. Alternatively, the posts may comprise wood or metal. A carpet may be applied to the structure to add aesthetic and functional qualities and can be adhered by various kinds of glue such as wood or hot, along with various kinds of nails and screws. With the post couplers providing a smooth exterior of the post, application of any carpentry is easier to apply and is more durable.

Each of the components of the animal structure described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### Description of Illustrated Embodiments

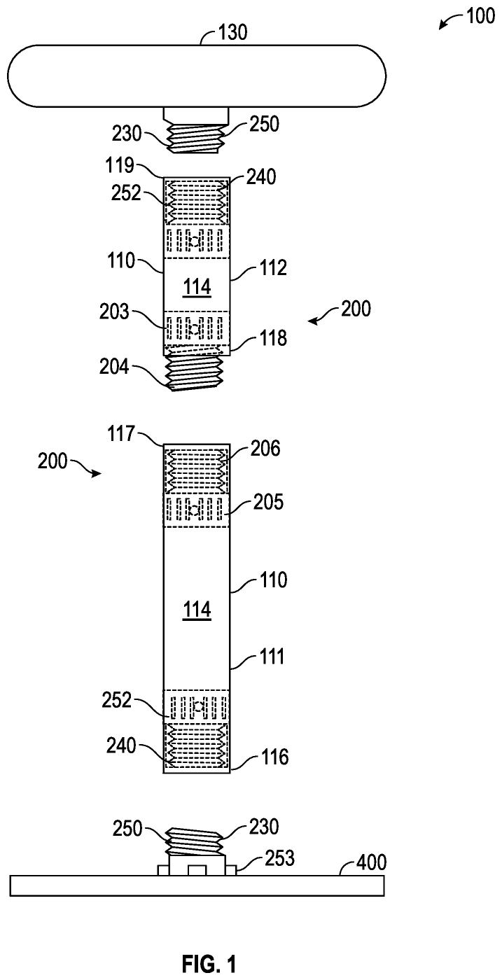

Now turning to the drawings, FIG. 1 shows a side view of an improved structure (100) having a post (110) with a first post section (111) and a second post section (112). The first post section comprises a first proximal end (116) and a first distal end (117) opposite the first proximal end. The second post section comprises a second proximal end (118) and a second distal (119) end opposite the second proximal end. The first proximal end of the first post section is coupled to a base (400). The first distal end is coupled to the second post section at the second proximal end. An optional median elevated surface (not shown) can be disposed between the first and second post sections. The second post section is coupled to a first elevated surface (130) at the second distal end. The first and second post sections each comprise a hollow interior (114).

As shown, means for coupling the first post section (111) with the second post section (112) is accomplished by a post coupler (200). The post coupler comprises a male subcomponent (201) and a female subcomponent (202). The male subcomponent comprises a male body (203) and a male connector (204) coupled to the male body. The female subcomponent comprises a female body (205) and a female connector (206) coupled to the female body. The male subcomponent is coupled to the second post section at the second proximal end (118) and the female subcomponent is coupled to the first post section at the first distal end (117). In other embodiments, the male subcomponent is coupled to the first post section and the female subcomponent is coupled to the second post section.

The first post section (111) is coupled to the base (400) by a base coupler (250). The first post section comprises a female portion (252) disposed with the first post section at the first proximal end (116). The base coupler comprises a male thread (250) configured to attach to the female portion. The female portion is disposed within the hollow interior (114) of the first post section. In embodiments, the first post section comprises a male portion and the base coupler comprises a female thread for engaging with the male portion. The base coupler (250) can additionally include arms (253) coupled to a surface of the base. The arms increase strength and support of the first post section with the base. Each of the arms can include a fastener aperture for increasing the coupling strength. In some embodiments, the male or female portion coupled to and disposed within the first post section is the same or similar male subcomponent (201) or female subcomponent (202) of the post coupler (200).

The post couplers (200) and base coupler (250) provide an advantage of securely coupling modular post sections while having an aesthetically smooth surface for climbing. Many kinds of posts are manufactured with outer diameters having low tolerances but inner diameters having high tolerances. One reason is because posts normally used for animal structures are pipes or tubes used in plumbing where coupling of said pipes or tubes occurs at an exterior thereof. Using a coupler disposed inside the hollow interior (114) can therefore be challenging given the variance of inner diameters between post sections.

Post couplers (200) disposed within the first and second post sections (111; 112) may have the male body (203) or female body (205) having an extended length which expands further into each of the post sections. This allows for a stronger coupling by preventing movement in the x and y directions.

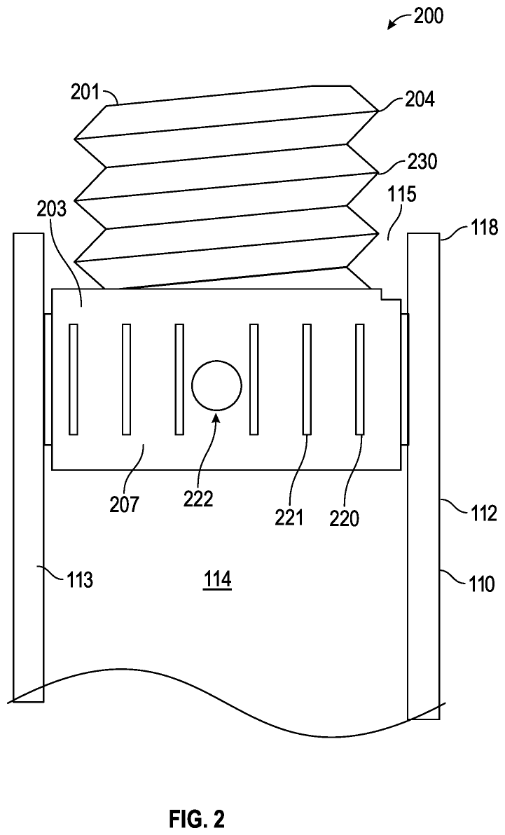

FIG. 2 shows a side view of a post (110) with a post coupler (200) disposed therein according to the first illustrated embodiment. More specially, the post is a second post section (112). The post coupler comprises a male subcomponent (201) having a male body (203). The male body comprises a male outer periphery (207). Coupled to the male body is a male connector (204) being a male thread (230). The male thread is configured to couple with a corresponding female thread. The male body comprises a plurality of apertures (222) and a plurality of ridges (221) disposed on the male outer periphery. Each of the plurality of apertures is configured to receive a fastener (such as a screw, bolt, nail, dowel or other known types of fasteners) wherein said fastener extends through the post and engages with one of the plurality of fasteners, thereby securing the male body to an inner wall (113) of the post. The plurality of ridges allows the post couplers to fit and align in posts having various sized inner diameters. The plurality of apertures allows the male subcomponent and female subcomponent to attach to the post.

The male subcomponent (201) of the post coupler (200) is disposed within a hollow interior (114) of the post (110). The male subcomponent is fully disposed within the hollow interior such that it is deep enough inside the post that the male body (203) is disposed below an opening (115) of the post. This ensures that the post remains flush between the junction of the first and second post sections.

The post (110) comprises holes (not shown) which align with the apertures (222) of the post coupler (200) to allow for easy alignment and insertion of fasteners. Preferably, the apertures of the post coupler and the holes of the post may comprise an amount of three or more. In a preferable embodiment, the spacing between the apertures and corresponding holes are evenly spaced such that an amount of three apertures is spaced one hundred and twenty degrees spaced, an amount of four apertures is spaced ninety degrees apart, etc.

The plurality of ridges (221) is semi-flexible which allows for conforming to the inner wall (113) when fitting post couplers (200) to the post (110). Semi-flexibility of the plurality of ridges can be achieved by design of material and/or a thickness (221) of each ridge thin enough to achieve the desired semi-flexibility. Semi-flexibility can be done with certain kinds of thermoplastics such that the plurality of ridges comprises a same material as both of the male body (203) and the female body. The plurality of ridges assists in ensuring a proper fit of the post coupler with a post having a variable post inner diameter.

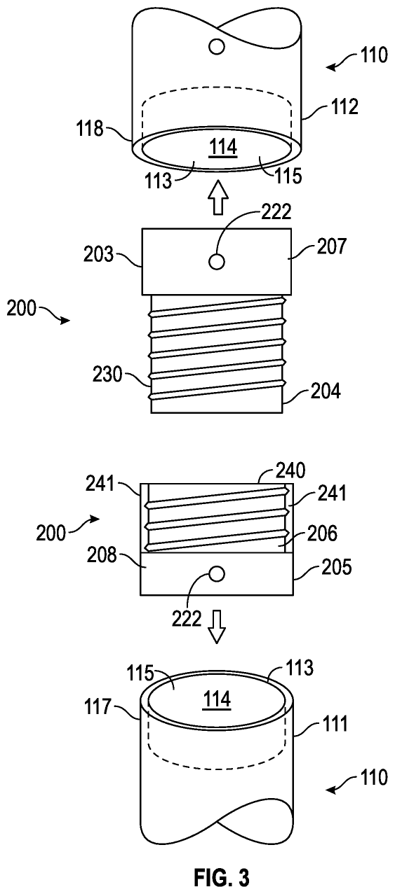

FIG. 3 shows a side view of a post (110) with a post coupler (200) according to the first illustrated embodiment. The post comprises a first post section (111) having a first distal end (117) and a second post section (112) having a second proximal end thereof. The post coupler comprises a male component (201) and a female subcomponent (202). The male subcomponent comprises a male body (203) having a male outer periphery (207). Coupled to the male body is a male connector (204) where the male connector comprises a male thread (230). The female subcomponent comprises a female body (205) having a female outer periphery (208). The female subcomponent further comprises a wall extension (241) extending from a perimeter of the female body, wherein a female connector (206) is disposed within the wall extension. As shown, the female connector is a female thread (240).

The post couplers (200) are configured to be disposed and coupled to a hollow interior (114) of the post (110) wherein the male body (203) and female body (205) are configured to contact an inner wall (113). The male body of the male subcomponent (201) is configured to be inserted first so that the male connector can protrude from an opening (115) of the post. As shown, the first post section (111) is configured to receive the female subcomponent (202) and the second post section (112) is configured to receive the male subcomponent. Once both male and female subcomponents are coupled with their respective post sections, the male and female connector (204; 206) can then engage each other until the first and second post sections are flush. This forms a post with a uniform body free from external attachments disposed on an outer surface of the post.

Disposed on both the male body (204) and female body (205) is an aperture (222). The male and female bodies may each comprise a plurality of apertures. A corresponding hole on each post section is made to align with one of the plurality of apertures.

The male connector (204) and the female connector (206) are shown as being a male thread (230) and a female thread (240). In alternative embodiments, other fastening mechanisms can be used as can be appreciated by one having skill in the art. In one embodiment, a friction fit can be utilized.

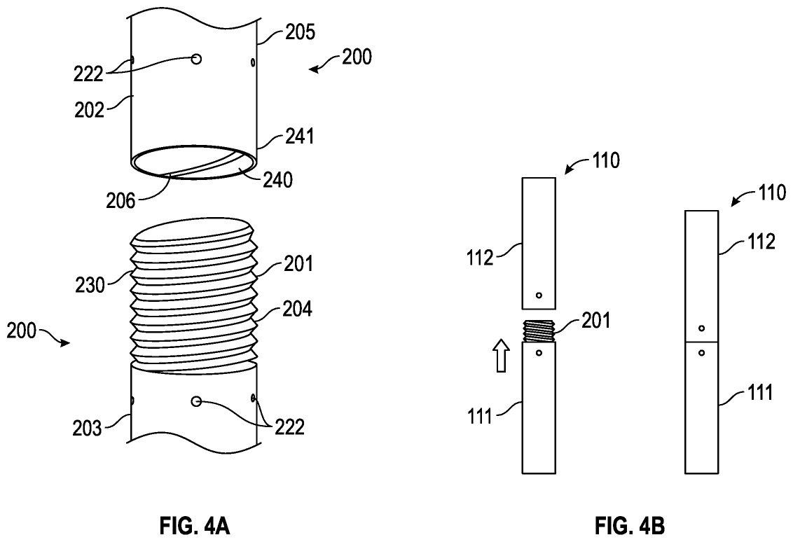

FIG. 4A and FIG. 4B show a post coupler (200) used to couple to a post (110) according to the first illustrated embodiment. The post coupler comprises a male subcomponent (201) and a female subcomponent (202). The female subcomponent comprises a female body (205) having a plurality of apertures (222) disposed thereon. The male subcomponent comprises a male body (203) also including the plurality of apertures. The male subcomponent further comprises a male connector (204) configured to fit within a female connector (206) of the female subcomponent. Once the male subcomponent is fully engaged with the female subcomponent, the post becomes flush.

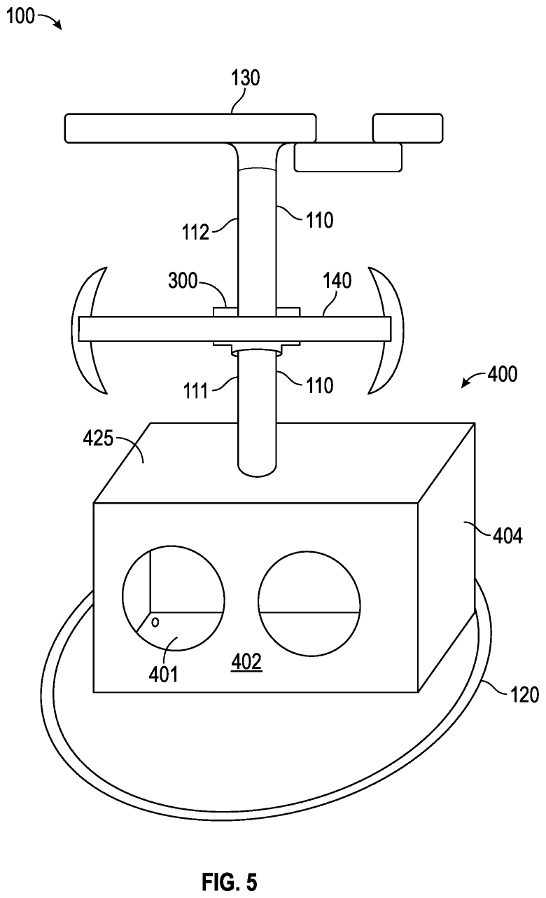

FIG. 5 shows perspective view of an improved animal structure (100) according to an embodiment. The animal structure comprises a post (110) extending from a base (400). The base is coupled to a stability platform (120). The post comprises a first post section (111) and a second post section (112). The first post section extends through the base and couples to a bottom portion (401) thereof. The second post section couples to an opposite end of the first post section to increase height of the overall post. Disposed between the first and second post sections is a median elevated platform (140). Disposed on an opposite end of the second post section is an upper elevated platform (130). The base comprises the bottom portion, a front portion (402), a back portion (403), and sides portions (404). The base may also comprise optional openings for providing inside access to animals. Located where the median elevated portion meets the first and second post sections is a stabilizer system (300).

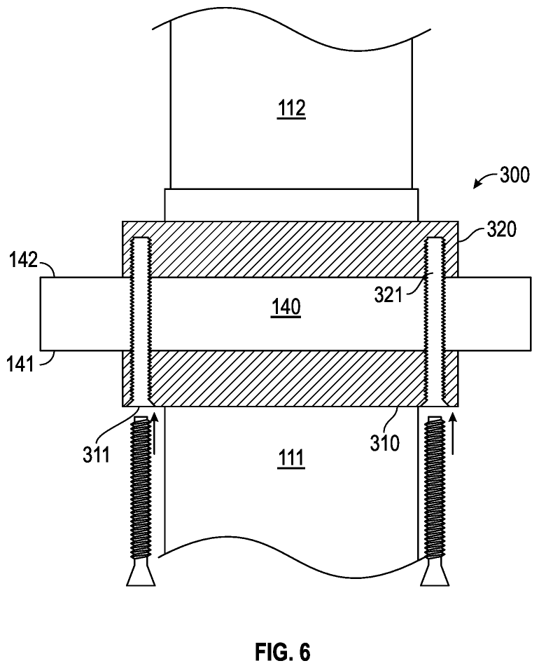

FIG. 6 shows side view of a stabilizer system (300) according to a second illustrated embodiment. The stabilizer system comprises first stabilizer component (310) and a second stabilizer component (320). The first stabilizer component is coupled to an exterior of a first post section (111) and the second stabilizer component is coupled to an exterior of a second post section (112). The first and second stabilizer components may couple to the exterior of the post sections by glue, nails, or other means which can be appreciated by one having skill in the art. Disposed between the first and second stabilizer components is a median elevated platform (140). The median elevated platform comprises a first surface (141) and a second surface opposite the first surface (142). The first stabilizer component is coupled to the first surface and the second stabilizer component is coupled to the second surface.

The stabilizer system (300) comprises a first fastener aperture (311) extending entirely through the first stabilizer component (310) and the median elevated (140). The first fastener aperture further extends partially into the second stabilizer component (320) such that a fastener disposed within the first fastener aperture does not protrude through the second stabilizer component. The stabilizer system further comprises a second fastener aperture (321) extending entirely through the first stabilizer component and the median elevated. The first fastener aperture further extends partially into the second stabilizer component such that a fastener disposed within the first fastener aperture does not protrude through the second stabilizer component

When the median elevated platform (140) is not present between the first and second stabilizer components (310; 320), a fastener of shorter length can be used to couple the first stabilizer component directly with the second stabilizer component, thereby increasing surface area between the first and second post sections (111; 112). The increased surface area increases strength at the joint which can be advantageous when weight is applied at an upper elevated platform (FIG. 5; 130) disposed above the stabilizer system (300). If the median elevated platform is present, corresponding apertures extending through the median elevated surface are located to align with both the apertures of the first stabilizer component and the second stabilizer component.

Coupling each of the first stabilizer component (310), the second stabilizer component (320), and the median elevated platform (140) together increases integrity when weight is applied to the upper elevated platform, the median elevated platform, or both. When the median elevated surface is disposed between the first and second stabilizer components, a fastener of greater length will be used.

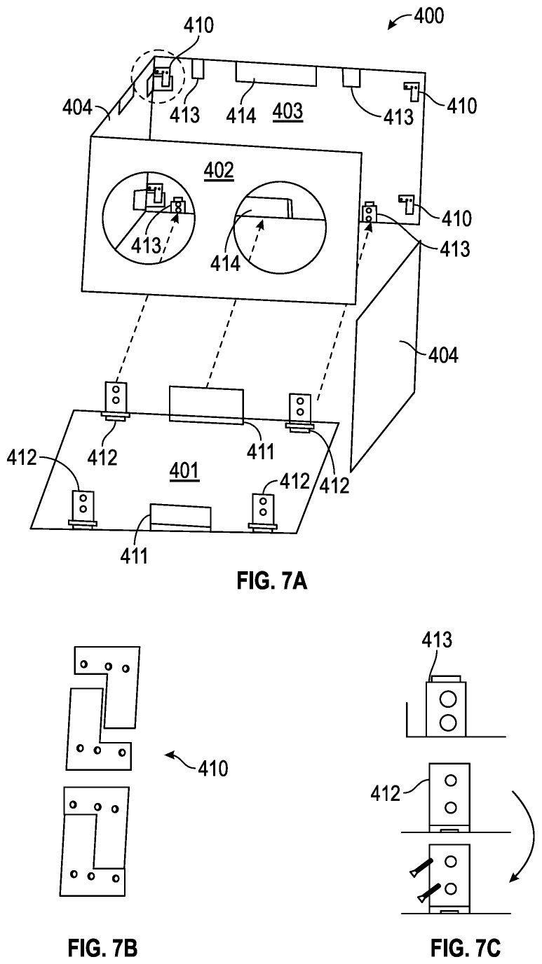

FIG. 7A-7C show a modular base (400) according to a third illustrated embodiment. The base comprises a bottom portion (401), top portion (not shown), front portion (402), back portion (403), and side portions (404). The base is configured to assemble and disassemble very easily with modular sides along with fast connection means.

The bottom portion (401) comprises two guides (411) disposed on opposite ends, in addition to male attachments (412) disposed on each corner. The front and back portions (402; 403) each comprise guide receivers (414) and female attachments (413) such that the guide receivers are each configured to receive one of the guides and the female attachments are each configured to receive one of the male attachments from the bottom portion. The top portion is coupled to the front and back portions in a similar fashion.

The front and back portions (402; 403), in addition to the side portions (404), comprise a connecting mechanism (410) for coupling the side portions to the base (400). The connecting mechanism may comprise a male and female insert, a hook and latch, or other mechanisms that can be appreciated by one having skill in the art.

The female attachments (413) coupled to the front and back portions (402; 403) may comprise a rectangular or semi-circle shape, but is preferable to have a flat surface for proper coupling to said front and back portions.

The male and female attachments (412; 413) may comprise holes for fasteners. The guides may not comprise such holes and instead are used to ensure proper alignment and increase structural integrity. It can be appreciated that holes on the female attachment are equal to or greater than holes on the male attachments to ensure sufficient clearance for a fastener.

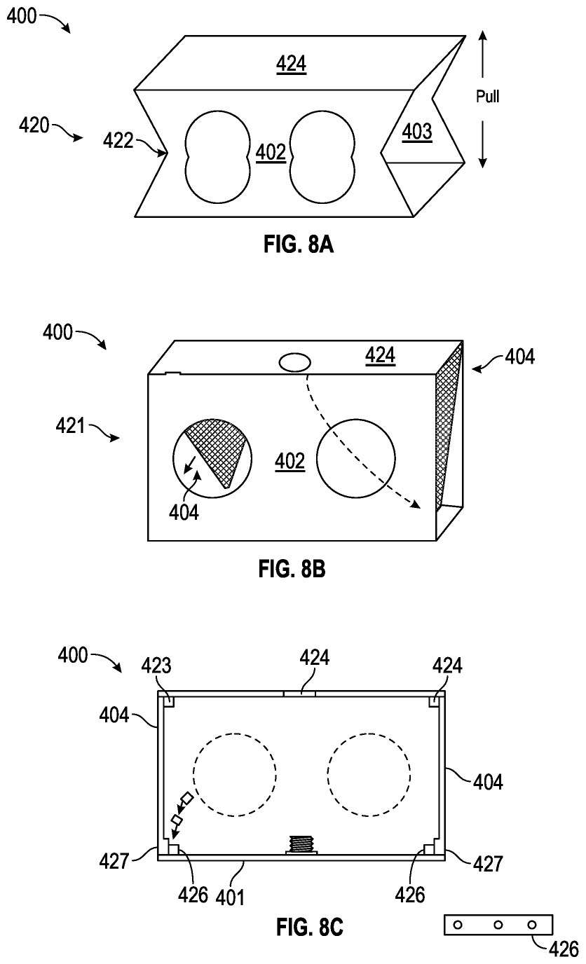

FIG. 8A-8C show a collapsible base (400) according to a fourth illustrated embodiment. The base comprises a front portion (402), a back portion (403), a bottom portion (401), a top portion (425), a two side portions (404). The front and back portion comprise a hinge or crease at a corresponding midsection (422) to allow the front and back portions to fold in half, causing the top portion to collapse on top of the bottom portion. The sides portions are hingedly coupled to the top portion by a first hinge (423) and second hinge (424), and are configured to rotate from the top portion when in a collapsed state (420) to the bottom portion when in an expanded state (421). In other embodiments, the side portions are hingedly coupled to the bottom portion and rotate upwards towards to the top portion.

The bottom portion (401) comprises stoppers (427) where each stopper is located near an edge of the bottom portion. The stoppers are configured to prevent the side portions (404) from rotating outwards from the bottom portion. After the base (400) has been put into an expanded state (421) with side portions rotated downward, a support bar (426) can be installed inside the base at the bottom portion to prevent the side portions from rotating into a collapsed state (420). Each of the side portions is held in place by the stopper on one side and the support bar on the other, thereby creating a rigid expanded structure.

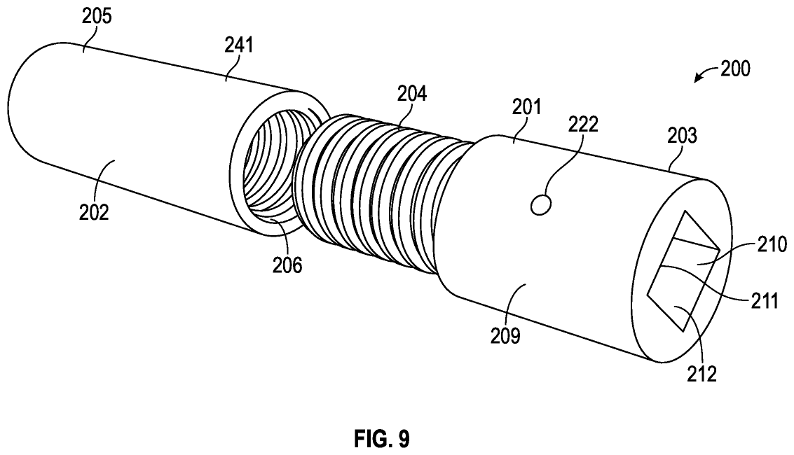

FIG. 9 shows a perspective view of the post coupler (200) in accordance with a fifth illustrated embodiment. The post coupler comprises a male subcomponent (201) and a female subcomponent wherein the male subcomponent is configured to attach to the female subcomponent. The female subcomponent comprises a female body (205) with a wall extension (241) extending from the female body. Disposed on an inner surface of the wall extension is a female connector (206). The male subcomponent comprises a male body (203) with a male connector (204) extending from the male body. The male connector is configured to couple with the female connector. One or more apertures (222) is disposed on the male body and female body for connecting with a corresponding post.

The male subcomponent (201) comprises a material having a subcomponent density (209). Extending longitudinally through both the male body (203) and the male connector (204) is a cavity (210). Disposed within the cavity is a core support (211) having a core density (212). In some embodiments, the core support occupies an entirety of the cavity. The core support may comprise wood or other materials. The core support provides a myriad of benefits to the post coupler (200). The male subcomponent may be made by additive manufacturing like 3D printing. Due to such processes, the male subcomponent is more susceptible to shearing because of the plurality of layers forming the male subcomponent. With the core support disposed within the cavity, the core support can strengthen the male subcomponent and resist breakage by shear force. Other benefits of the core support include a lighter weight of the male subcomponent when the core density is less than the subcomponent density. In yet another benefit, the core support allows a fastener which fastens the male body (203) to a post via the aperture (222) to terminate at the core support instead of the more brittle male body, thereby increasing strength.

While various details, features, and combinations are described in the illustrated embodiments, one having skill in the art will appreciate a myriad of possible alternative combinations and arrangements of the features disclosed herein. As such, the descriptions are intended to be enabling only, and non-limiting. Instead, the spirit and scope of the invention is set forth in the appended claims.

### Feature List

animal structure (100)

post (110)

first post section (111)

second post section (112)

inner wall (113)

hollow interior (114)

opening (115)

first proximal end (116)

first distal end (117)

second proximal end (118)

second distal end (119)

stability platform (120)

upper elevated platform (130)

median elevated surface (140)

first surface (141)

second surface (142)

post coupler (200)

male subcomponent (201)

female subcomponent (202)

male body (203)

male connector (204)

female body (205)

female connector (206)

male outer periphery (207)

female outer periphery (208)

subcomponent density (209)

cavity (210)

core support (211)

core density (212)

plurality of ridges (220)

thickness (221)

aperture (222)

male thread (230)

female thread (240)

wall extension (241)

base coupler (250)

male portion (251)

female portion (252)

arms (253)

stabilizer system (300)

first stabilizer component (310)

first fastener aperture (311)

second stabilizer component (320)

second fastener aperture (321)

base (400)

bottom portion (401)

front portion (402)

back portion (403)

side portions (404)

connecting mechanism (410)

guide (411)

male attachment (412)

female attachment (413)

guide receiver (414)

collapsed state (420)

expanded state (421)

midsection (422)

first hinge (423)

second hinge (424)

top portion (425)

support bar (426)

stopper (427)

What is claimed is:

1. An improved animal structure, comprising:
a post comprising a first post section and a second post section configured to detach from the first post section, the first post section comprising a first distal end and a first proximal end opposite the first distal end, the second post section comprising a second distal end and a second proximal end opposite the first distal end, the post further comprising a hollow interior forming an inner wall;
a base coupled to the first post section at the first proximal end;
a post coupler coupled to the post at both the first distal end and the second proximal end, wherein the post coupler is disposed entirely within the hollow interior, the post coupler comprising:
a male subcomponent, the male subcomponent having a male connector coupled to a male body, the male body comprising a male outer periphery wherein the male outer periphery is coupled to the inner wall of the post,
a female subcomponent configured to engage with the male subcomponent, the female subcomponent having a female body with a wall extension extending from the female body, the wall extension comprising a female connector, the female body further comprising a female outer periphery wherein the female outer periphery is coupled to the inner wall of the post,
a plurality of ridges disposed on both the male outer periphery and the female outer periphery, the plurality of ridges extending in a same direction as the post, the plurality of ridges comprise a thickness configured to conform to the inner wall,
a plurality of apertures extending through both the male body and the female body, wherein a plurality of fasteners extends through the post and engages with the plurality of apertures
wherein the male body and female body are fully disposed within the hollow interior; and
a median elevated platform coupled to the post by a stabilizer system, the stabilizer system comprising:
a first stabilizer component coupled to a first surface of the median elevated platform,
a second stabilizer component coupled to a second surface of the median platform, and
a plurality of fastener apertures, wherein each of the plurality of fastener apertures extends completely through the first stabilizer component and the median elevated platform, and further wherein each of the plurality of fastener apertures extends partially into the second stabilizer component.

2. The improved animal structure of claim 1, the post further comprising one of a male portion or female portion coupled to the inner wall of the first proximal end, wherein the male portion or female portion is configured to engage with a base coupler, the base coupler being attached to the base.

3. The improved animal structure of claim 1, the base further comprising a collapsible base, the collapsible base comprising:
a top portion;
a bottom portion opposite the top portion;
a front portion coupled to each of the top portion and the bottom portion;
a back portion opposite the front portion, the back portion coupled to each of the top portion and the bottom portion; and
a plurality of side portions hingedly coupled to the top portion;
wherein the front portion and the back portion each comprise a hinge extending along a corresponding midsection, thereby allowing the front and back portions to fold and cause the top portion to collapse onto the bottom portion.

4. The improved animal structure of claim 7, the bottom portion further comprising a plurality of stoppers wherein each stopper is configured to prevent the plurality of side portions from rotating outwards from the bottom portion.

5. The improved animal structure of claim 8, the bottom portion further comprising a plurality of support bars, the plurality of support bars being coupled to the bottom portion to prevent the plurality of side portions from rotating into a collapsed state, wherein each of the plurality of side portions is held in place by one of the plurality of stoppers on a side and one of the plurality of support bars on an opposite side.

6. The improved animal structure of claim 1, the base further comprising a modular base, the modular base comprising:
a bottom portion, the bottom portion comprising a plurality of guides and a plurality of male attachments;
a front portion and a back portion opposite the front portion, wherein the front portion and the back portion each comprise one or more guide receivers configured to engage with one of the plurality of guides, the front portion and back portion each comprising a plurality of female attachments each configured to engage with one of the plurality of male attachments; and
a plurality of side portions configured to couple to each of the front portion and the back portion by a connecting mechanism.

7. The improved animal structure of claim 1, the male subcomponent further comprising a cavity extending through each of the male body and male connector, wherein a core support is disposed within the cavity.

8. The improved animal structure of claim 7, the male subcomponent further comprising a subcomponent density and the core support comprising a core density, wherein the core density is less than the subcomponent density.

9. An improved animal structure, comprising:
a post comprising a first post section and a second post section configured to detach from the first post section, the first post section comprising a first distal end and a first proximal end opposite the first distal end, the second post section comprising a second distal end and a second proximal end opposite the first distal end, the post further comprising a hollow interior forming an inner wall;
a base coupled to the first post section at the first proximal end; and
a post coupler coupled to the post at both the first distal end and the second proximal end, wherein the post coupler is disposed entirely within the hollow interior, the post coupler comprising:
a male subcomponent, the male subcomponent having a male connector coupled to a male body, the male body comprising a male outer periphery wherein the male outer periphery is coupled to the inner wall of the post,
a female subcomponent configured to engage with the male subcomponent, the female subcomponent having a female body with a wall extension extending from the female body, the wall extension comprising a female connector, the female body further comprising a female outer periphery wherein the female outer periphery is coupled to the inner wall of the post.

10. The improved animal structure of claim 9, further comprising a plurality of ridges disposed on both the male outer periphery and the female outer periphery.

11. The improved animal structure of claim 10, wherein the plurality of ridges extends in a same direction as the post.

12. The improved animal structure of claim 9, further comprising a plurality of apertures extending through both the male body and the female body, wherein a plurality of fasteners extends through the post and engages with the plurality of apertures.

13. The improved animal structure of claim 9, further comprising a median elevated platform coupled to the post by a stabilizer system, the stabilizer system comprising:
a first stabilizer component coupled to a first surface of the median elevated platform;
a second stabilizer component coupled to a second surface of the median platform; and
a plurality of fastener apertures, wherein each of the plurality of fastener apertures extends completely through the first stabilizer component and the median elevated platform, and further wherein each of the plurality of fastener apertures extends partially into the second stabilizer component.

14. The improved animal structure of claim 9, the post further comprising one of a male portion or female portion coupled to the inner wall of the first proximal end, wherein the male portion or female portion is configured to engage with a base coupler, the base coupler being attached to the base.

15. The improved animal structure of claim 9, the base further comprising a collapsible base, the collapsible base comprising:
a top portion;
a bottom portion opposite the top portion;
a front portion coupled to each of the top portion and the bottom portion;
a back portion opposite the front portion, the back portion coupled to each of the top portion and the bottom portion; and
a plurality of side portions hingedly coupled to the top portion;
wherein the front portion and the back portion each comprise a hinge extending along a corresponding midsection, thereby allowing the front and back portions to fold and cause the top portion to collapse onto the bottom portion.

16. The improved animal structure of claim 15, the bottom portion further comprising a plurality of stoppers wherein each stopper is configured to prevent the plurality of side portions from rotating outwards from the bottom portion.

17. The improved animal structure of claim 16, the bottom portion further comprising a plurality of support bars, the plurality of support bars being coupled to the bottom portion to prevent the plurality of side portions from rotating into a collapsed state, wherein each of the plurality of side portions is held in place by one of the plurality of stoppers on a side and one of the plurality of support bars on an opposite side.

18. The improved animal structure of claim 9, the base further comprising a modular base, the modular base comprising:
a bottom portion, the bottom portion comprising a plurality of guides and a plurality of male attachments;
a front portion and a back portion opposite the front portion, wherein the front portion and the back portion each comprise one or more guide receivers configured to engage with one of the plurality of guides, the front portion and back portion each comprising a plurality of female attachments each configured to engage with one of the plurality of male attachments; and
a plurality of side portions configured to couple to each of the front portion and the back portion by a connecting mechanism.

19. The improved animal structure of claim 9, the male subcomponent further comprising a cavity extending through each of the male body and male connector, wherein a core support is disposed within the cavity.

20. The improved animal structure of claim 19, the male subcomponent further comprising a subcomponent density and the core support comprising a core density, wherein the core density is less than the subcomponent density.
